(19) United States
(12) Patent Application Publication
(10) Pub. No.: US 2024/0039300 A1
(43) Pub. Date: Feb. 1, 2024

(54) BATTERY CONTROL APPARATUS, OPERATING METHOD THEREOF, AND BATTERY CONTROL SYSTEM

(71) Applicant: LG ENERGY SOLUTION, LTD., Seoul (KR)

(72) Inventor: Yean Sik CHOI, Daejeon (KR)

(73) Assignee: LG ENERGY SOLUTION, LTD., Seoul (KR)

(21) Appl. No.: 18/039,924

(22) PCT Filed: Jul. 11, 2022
(86) PCT No.: PCT/KR2022/010029

§ 371 Date: Jun. 1, 2023

(30) Foreign Application Priority Data
Aug. 2, 2021 (KR) 10-2021-0101623

(51) Int. Cl. H02J 7/00; H01M 10/42; H01M 10/44

(52) U.S. Cl. CPC H02J 7/0014; H01M 10/425; H01M 10/441; H02J 7/0048; H02J 7/005; H01M 2010/4278; H01M 2010/4271; H01M 2220/20

(57) ABSTRACT

Discussed is a battery control apparatus that may include an information obtaining unit configured to obtain information about a mobility, information about a first battery configured to supply power to a module included in the mobility, and information about a second battery provided in the module and configured to supply power to the module as an auxiliary power source for the first battery based on an operation of the mobility and a controller configured to generate a control signal for controlling an operation of the first battery and an operation of the second battery based on the information about the mobility, the information about the first battery, and the information about the second battery.

### CROSS-REFERENCE TO RELATED APPLICATION

This application claims priority to and the benefit of Korean Patent Application No. 10-2021-0101623 filed in the Korean Intellectual Property Office on Aug. 2, 2021, the entire contents of which are incorporated herein by reference.

### TECHNICAL FIELD

Embodiments disclosed herein relate to a battery control apparatus, an operating method thereof, and a battery control system.

### BACKGROUND ART

Recently, research and development of secondary batteries have been actively performed. Herein, the secondary batteries, which are chargeable/dischargeable batteries, may include all of conventional nickel (Ni)/cadmium (Cd) batteries, Ni/metal hydride (MH) batteries, etc., and recent lithium-ion batteries. Among the secondary batteries, a lithium-ion battery has a much higher energy density than those of the conventional Ni/Cd batteries, Ni/MH batteries, etc. Moreover, the lithium-ion battery may be manufactured to be small and lightweight, such that the lithium-ion battery has been used as a power source of mobile devices, and recently, a use range thereof has been extended to power sources for electric vehicles, attracting attention as next-generation energy storage media.

Mobility collectively refers to means of transportation with mobility. For a battery used in mobility, it is essential to manage the degradation degree of the battery in order to increase the lifespan of the battery. Since air mobility operates in the sky, it may not be able to stop unlike mobility that is driven on the ground, such that problems may occur in case of emergency.

### DISCLOSURE

### Technical Problem

Embodiments disclosed herein aim to provide a battery control apparatus, an operating method thereof, and a battery control system to efficiently control an operation of a battery provided in mobility.

Technical problems of the embodiments disclosed herein are not limited to the above-described technical problems, and other unmentioned technical problems would be clearly understood by one of ordinary skill in the art from the following description.

### Technical Solution

A battery control apparatus according to an embodiment disclosed herein may include an information obtaining unit configured to obtain information about a mobility, information about a first battery configured to supply power to a module included in the mobility, and information about a second battery provided in the module and configured to supply power to the module as an auxiliary power source for the first battery based on an operation of the mobility and a controller configured to generate a control signal for controlling an operation of the first battery and an operation of the second battery based on the information about the mobility, the information about the first battery, and the information about the second battery.

In an embodiment, the controller may be further configured to generate a control signal for controlling the second battery to assist power supply of the first battery by charging or discharging the second battery based on a speed or an instantaneous speed of the mobility.

In an embodiment, the controller may be further configured to generate a control signal for controlling to perform balancing between a plurality of second batteries when a deviation in a state of charge (SOC) or a state of health (SOH) between the plurality of second batteries is greater than or equal to a reference value.

In an embodiment, the controller may be further configured to, when an abnormality occurs in at least one second battery, generate a control signal for controlling the operations of the first battery and the second battery to perform an emergency driving mode of the mobility based on the operation of the first battery and operations of the plurality of second batteries other than the at least one second battery having the abnormality.

In an embodiment, the controller may be further configured to, when a number of the plurality of second batteries having the abnormality among the plurality of second batteries is greater than or equal to a preset value, generate a control signal for controlling the operations of the first battery and the second battery to perform the emergency driving mode of the mobility based on the operation of the first battery.

In an embodiment, the controller may be further configured to, when an abnormality occurs in the first battery, generate a control signal for controlling the operations of the first battery and the second battery to perform the emergency driving mode of the mobility based on the operation of the second battery.

An operating method of a battery control apparatus according to an embodiment disclosed herein includes obtaining information about a mobility, information about a first battery configured to supply power to a module included in the mobility, and information about a second battery provided in the module and configured to supply power to the module as an auxiliary power source for the first battery based on an operation of the mobility and generating a control signal for controlling an operation of the first battery and an operation of the second battery based on the information about the mobility, the information about the first battery, and the information about the second battery.

In an embodiment, the generating of the control signal for controlling the operations of the first battery and the second battery, based on the obtained information, may include generating a control signal for controlling the second battery to assist power supply of the first battery by charging or discharging the second battery based on a speed or an instantaneous speed of the mobility.

In an embodiment, the second battery may be provided in plural, and the generating of the control signal for controlling the operations of the first battery and the second battery, based on the obtained information, may include determining whether a deviation in a state of charge (SOC) or a state of health (SOH) between the plurality of second batteries is greater than or equal to a reference value and generating a control signal for controlling to perform balancing between the plurality of second batteries.

In an embodiment, the generating of the control signal for controlling the operations of the first battery and the second battery, based on the obtained information, may include determining whether an abnormality occurs in at least one second battery and generating a control signal for controlling the operations of the first battery and the second battery to perform an emergency driving mode of the mobility based on the operation of the first battery and operations of the plurality of second batteries other than the at least one second battery having the abnormality.

In an embodiment, the generating of the control signal for controlling the operations of the first battery and the second battery, based on the obtained information may include determining whether a number of the plurality of second batteries having the abnormality among the plurality of second batteries is greater than or equal to a preset value and generating a control signal for controlling the operations of the first battery and the second battery to perform the emergency driving mode of the mobility based on the operation of the first battery.

In an embodiment, the generating of the control signal for controlling the operations of the first battery and the second battery, based on the obtained information may include determining whether an abnormality occurs in the first battery and generating a control signal for controlling the operations of the first battery and the second battery to perform the emergency driving mode of the mobility based on the operation of the second battery.

A battery control system according to an embodiment disclosed herein includes a first battery configured to supply power to a module included in a mobility, a second battery provided in the module and configured to supply power to the module as an auxiliary power source for the first battery based on an operation of the mobility, and a control apparatus configured to obtain information about the mobility, information about the first battery, and information about the second battery and control operations of the first battery and the second battery based on the obtained information.

In an embodiment, the control apparatus is further configured to control to assist power supply of the first battery by charging or discharging the second battery based on a speed or an instantaneous speed of the mobility.

In an embodiment, the second battery may be provided in plural, and the control apparatus may be further configured to control to perform balancing between the plurality of second batteries when a deviation in a state of charge (SOC) or a state of health (SOH) between the plurality of second batteries is greater than or equal to a reference value.

In an embodiment, the second battery may be provided plural, and the control apparatus may be further configured to, when an abnormality occurs in at least one second battery, perform an emergency driving mode of the mobility based on the operation of the first battery and operations of the plurality of second batteries other than the at least one second battery having the abnormality.

In an embodiment, the control apparatus may be further configured to, when a number of plurality of second batteries having the abnormality among the plurality of second batteries is greater than or equal to a preset value, perform the emergency driving mode of the mobility based on the operation of the first battery.

In an embodiment, the control apparatus may be further configured to, when an abnormality occurs in the first battery, perform the emergency driving mode of the mobility based on the operation of the second battery.

### Advantageous Effects

A battery control apparatus according to an embodiment disclosed herein may manage a degradation degree of a battery included in mobility, by controlling an operation of the battery based on information regarding the mobility and information regarding the battery.

The battery control apparatus according to an embodiment disclosed herein may allow mobility to efficiently reach a target speed or an instantaneous speed, by controlling an operation of a battery included in the mobility based on information regarding the mobility and information regarding the battery.

The battery control apparatus according to an embodiment disclosed herein may enable an emergency driving mode to operate in case of abnormality occurring in a battery included in mobility, by controlling an operation of the battery based on information regarding the mobility and information regarding the battery.

Moreover, various effects recognized directly or indirectly from the disclosure may be provided.

### DESCRIPTION OF DRAWINGS

FIG. 1 illustrates mobility according to an embodiment disclosed herein.

FIG. 2 is a block diagram of a battery control system according to an embodiment disclosed herein.

FIG. 3 illustrates a battery control apparatus according to an embodiment disclosed herein.

FIG. 4 shows an example where a battery control apparatus according to an embodiment disclosed herein controls a battery based on a speed of mobility.

FIGS. 5 and 6 show an example where a battery control apparatus according to an embodiment disclosed herein controls a battery based on an instantaneous speed of mobility.

FIG. 7 is a flowchart of an operating method of a battery control apparatus according to an embodiment disclosed herein.

FIGS. 8 to 10 are flowcharts that further illustrate an operating method of a battery control apparatus according to an embodiment disclosed herein.

### MODE FOR INVENTION

Hereinafter, embodiments disclosed in this document will be described in detail with reference to the exemplary drawings. In adding reference numerals to components of each drawing, it should be noted that the same components are given the same reference numerals even though they are indicated in different drawings. In addition, in describing the embodiments disclosed in this document, when it is determined that a detailed description of a related known configuration or function interferes with the understanding of an embodiment disclosed in this document, the detailed description thereof will be omitted.

To describe a component of an embodiment disclosed herein, terms such as first, second, A, B, (a), (b), etc., may be used. These terms are used merely for distinguishing one component from another component and do not limit the component to the essence, sequence, order, etc., of the component. The terms used herein, including technical and scientific terms, have the same meanings as terms that are generally understood by those skilled in the art, as long as the terms are not differently defined. Generally, the terms defined in a generally used dictionary should be interpreted as having the same meanings as the contextual meanings of the relevant technology and should not be interpreted as having ideal or exaggerated meanings unless they are clearly defined in the present application.

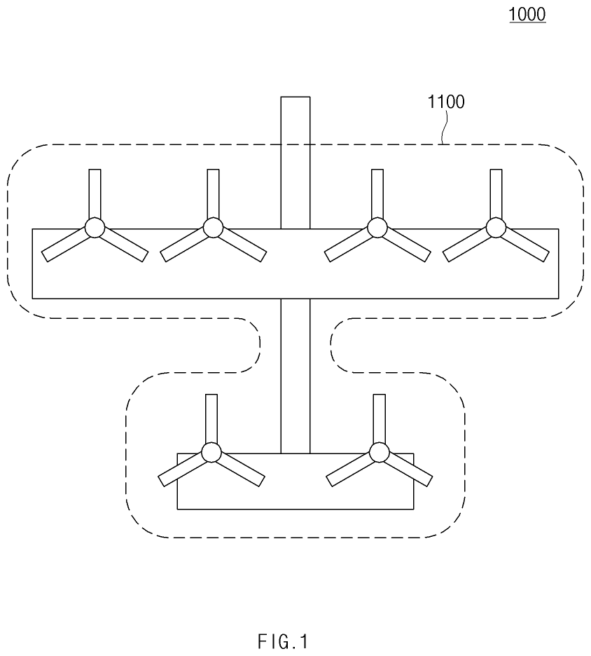

FIG. 1 illustrates mobility according to an embodiment disclosed herein.

Referring to FIG. 1, mobility 1000 may refer to means with mobility. For example, the mobility 1000 may include at least any one of a vehicle, an electric quick board, an airplane, a drone, a helicopter, a train, a bicycle, or a motorcycle. In another example, the mobility 1000 may include means capable of having mobility through at least one energy of electricity, hydrogen, or fuel. Although the mobility 1000 is illustrated in the shape of an airplane in FIG. 1, the present disclosure is not limited thereto.

The mobility 1000 may include a module 1100. For example, the mobility 1000 may include a plurality of modules 1100. Although the module 1100 is illustrated in the shape of a propeller in FIG. 1, the present disclosure is not limited thereto. That is, the module may include a device driven using energy to enable the mobility 1000 to move.

The mobility 1000 may be driven through a battery. For example, each module 1100 may include a battery and may be driven based on energy of the included battery. In another example, the mobility 1000 may include a battery capable of supplying energy to the mobility 1000 and the module 1100. The mobility 1000 may include a battery control apparatus capable of controlling an operation of the battery to efficiently manage and use (charge or discharge) the battery.

The mobility 1000 according to an embodiment disclosed herein may control an operation of the battery through the battery control apparatus such that each module 1100 and the mobility 1000 may be efficiently driven.

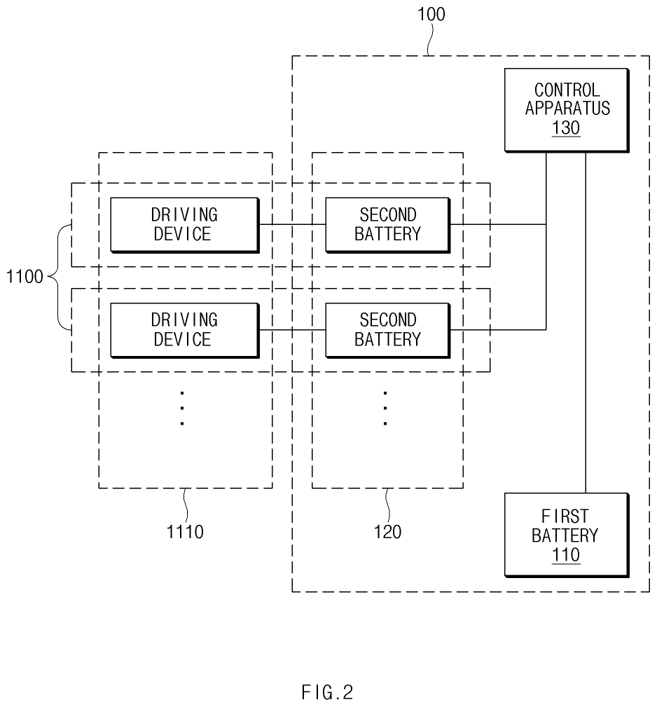

FIG. 2 is a block diagram of a battery control system according to an embodiment disclosed herein.

Referring to FIG. 2, a battery control system 100 according to an embodiment disclosed herein may include a first battery 110, a second battery 120, and a control apparatus 130. The module 1100 may be substantially the same as the module 1100 of FIG. 1. In an embodiment, each module 1100 may include a driving device 1110 and the second battery 120. For example, the driving device 1110 may include a motor (not shown) and an inverter (not shown). In another example, the driving device 1110 may be provided with power of the first battery 110 and power of the second battery 120 in parallel.

The first battery 110 may supply power to each module 1100 included in mobility. For example, the first battery 110, which is a base battery, may supply power to every modules 1100 included in the mobility. The first battery 110 may be, for example, a lithium ion (Li-ion) battery, an Li-ion polymer battery, a nickel-cadmium (Ni—Cd) battery, a nickel hydrogen (Ni-MH) battery, etc., and are not limited thereto. In an embodiment, the first battery 110 may include at least any one of a plurality of battery cells (not shown), a plurality of battery modules (not shown), or a plurality of battery packs (not shown).

The second battery 120 may be provided in each module 1100. For example, each module 1100 may include the second battery 120. The second battery 120 may be, for example, an Li-ion battery, an Li-ion polymer battery, an Ni—Cd battery, an Ni-MH battery, etc., and are not limited thereto.

The second battery 120 as an auxiliary power source for the first battery 110 may supply power to the module 1100 based on an operation of the mobility. For example, the second battery 120 may supply power to each module 1100 when additional charging or discharging of power as well as power supplied to the module 1110 from the first battery 110 is required. In an embodiment, the second battery 120 included in each module 1100 may supply power of a different magnitude to the module 1100 connected thereto. In an embodiment, the number of second batteries 120 may be plural and may be equal to the number of modules 1100.

The control apparatus 130 may control operations of the first battery 110 and the second battery 120. For example, the control apparatus 130 may obtain information regarding the first battery 110, the second battery 120, and mobility, and control operations of the first battery 110 and the second battery 120 based on the obtained information. In an embodiment, the control apparatus 130 may be supplied with power from the first battery 110. In an embodiment, the control apparatus 130 may control outputs (power supply) of the first battery 110 and the second battery 120.

The control apparatus 130 may control to assist power supply (outputs, operations) of the first battery 110 by charging or discharging the second battery 120 based on a speed or an instantaneous speed of the mobility. For example, when a target speed of the mobility to be reached is higher than a maximum speed obtainable by supplying power to the module 1100 from the first battery 110, the control apparatus 130 may control outputs of the first battery 110 and the second battery 120 in such a way to enable the mobility to reach the target speed by controlling the second battery 120 to be discharged to. In another example, when the instantaneous speed of the mobility has to be lowered, the control apparatus 130 may first reduce the speed of the driving device 1110 included in the module 1100 by controlling the second battery 120 to recover (charge) power from the module 1100 and then control the outputs of the first battery 110 and the second battery 120 to enable the mobility to quickly reach the target speed by controlling the output of the first battery 110 to be lowered. In another example, when the instantaneous speed of the mobility has to be increased, the control apparatus 130 may first reduce the speed of the driving device 1110 included in the module 1100 by controlling the second battery 120 to supply (discharge) power and then control the operations of the first battery 110 and the second battery 120 to enable the mobility to quickly reach the target speed by controlling the output of the first battery 110 to be increased.

The control apparatus 130 may perform balancing between the second batteries 120 when a deviation in state of charge (SOC) or state of health (SOH) between the second batteries 120 is greater than or equal to a reference value. For example, when any one of the second batteries has an SOC or an SOH that is different from that of another second battery by a reference value or more, the control apparatus 130 may control the operation of the second battery 120 to balance SOCs and SOHs of the second batteries 120 while performing normal driving of the mobility by additionally using a driving device connected to the module corresponding to the other second battery. That is, the control apparatus 130 may control the operation of the second battery 120 such that the degradation degree differs between the second batteries 120 by the reference value or less.

When abnormality occurs in at least one of the second batteries 120, the control apparatus 130 may perform an emergency driving mode of the mobility based on operations of the other second batteries except for the first battery 110 and the second battery having abnormality. For example, when driving is possible at the target speed merely with outputs of the first battery and the other second batteries than the second battery having abnormality, the control apparatus 130 may power off the driving device connected to the second battery having abnormality to perform emergency driving. That is, the emergency driving mode may be a mode to power off the driving device connected to the second battery having abnormality when driving of the mobility is possible at an existing speed.

When the number of second batteries having abnormality among the second batteries is greater than or equal to a preset value, the control apparatus 130 may perform the emergency driving mode of the mobility based on the operation of the first battery. For example, the control apparatus 130 may set the preset value based on the target speed of the mobility, and when the driving of the mobility is not possible at the target speed because the number of second batteries having abnormality among the second batteries is greater than or equal to the preset value, then the control apparatus 130 may control to drive the mobility merely using the first battery 110. That is, the control apparatus 130 may power off the driving devices connected to all second batteries and may control to drive the mobility merely with the output of the first battery 110. In an embodiment, the control apparatus 130 may perform the emergency driving mode of the mobility based on position information of the second battery having abnormality among the second batteries.

When abnormality occurs in the first battery 110, the control apparatus 130 may perform the emergency driving mode of the mobility based on the operation of the second battery 120. For example, when the control apparatus 130 determines that abnormality occurs in the first battery 110, the control apparatus 130 may stop using the first battery 110 and continuously operate by receiving power from any one of the second batteries, and may control to drive the mobility based on the operation of the second battery 120.

The battery control system 100 according to an embodiment disclosed herein may control the mobility to reach the target speed or target instantaneous speed by controlling the operations of the first battery 110 and the second battery 120 through the control apparatus 130, may balance the degradation degrees of the second batteries 120, and may perform the emergency driving mode in case of emergency of the mobility.

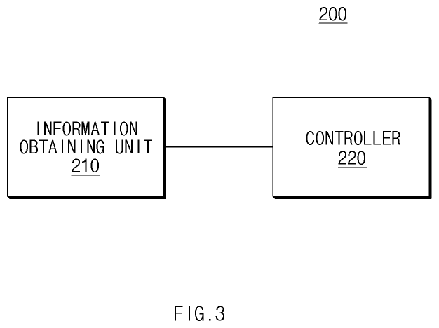

FIG. 3 illustrates a battery control apparatus according to an embodiment disclosed herein.

Referring to FIG. 3, a battery control apparatus 200 according to an embodiment disclosed herein may include an information obtaining unit 210 and a controller 220. In an embodiment, the battery control apparatus 200 may be substantially the same as the control apparatus 130 of FIG. 2.

The information obtaining unit 210 may obtain information about mobility. For example, the information obtaining unit 210 may obtain at least any one of a target speed, a target instantaneous speed, a current speed, a maximum speed, or a minimum speed of the mobility.

The information obtaining unit 210 may obtain information about a first battery that supplies power to each module included in the mobility. For example, the first battery may be substantially the same as the first battery 110 of FIG. 2. In another example, the information about the first battery may include at least any one of a voltage, a current, a temperature, an insulating resistance, an SOC, an SOH, or a failure of the first battery.

The information obtaining unit 210 may obtain information about a second battery that supplies power to each module as an auxiliary power source for the first battery based on the operation of the mobility. For example, the second battery may be substantially the same as the second battery 120 of FIG. 2. In another example, the information about the second battery may include at least any one of a voltage, a current, a temperature, an insulating resistance, an SOC, an SOH, or a failure of the second battery.

The controller 220 may generate a control signal for controlling the operations of the first battery and the second battery, based on the obtained information. For example, the controller 220 may control the mobility to be driven normally by generating the control signal for controlling the operations of the first battery and the second battery based on information about the mobility, the first battery, and the second battery.

The controller 220 may generate a control signal for controlling the second battery to assist the output of the first battery by charging or discharging the second battery based on the speed or instantaneous speed of the mobility. For example, the controller 220 may generate a control signal for controlling the second battery to assist power supply (output) of the first battery by additionally supplying power of the second battery to the module based on the target speed or target instantaneous speed of the mobility or using the power supplied to the module by the second battery.

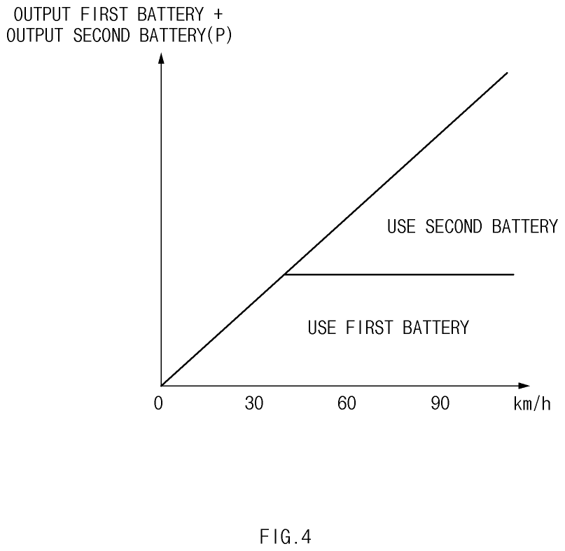

FIG. 4 shows an example where a battery control apparatus according to an embodiment disclosed herein controls a battery based on a speed of mobility.

Referring to FIG. 4, when a speed that may not be reached with the output of the first battery is the target speed of the mobility, the controller 220 may generate a control signal for controlling the operation of the second battery to allow the mobility to reach the target speed by additionally supplying the output of the second battery to the module.

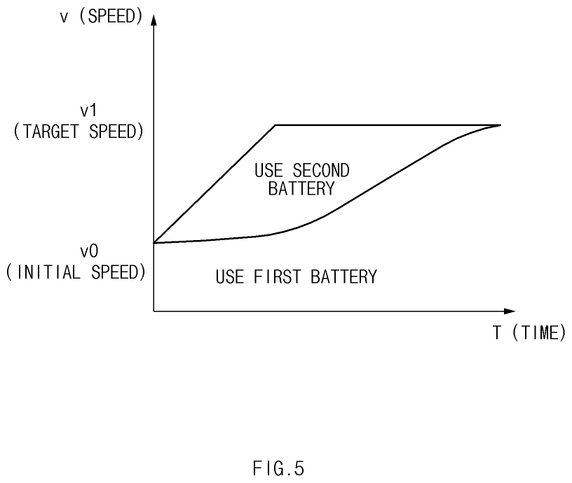

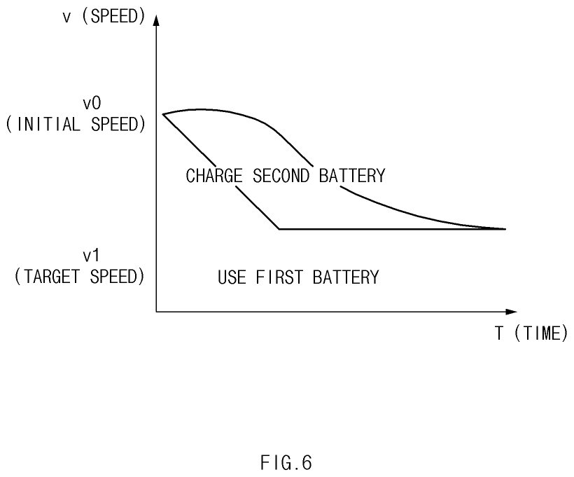

FIGS. 5 and 6 show an example where a battery control apparatus according to an embodiment disclosed herein controls a battery based on an instantaneous speed of mobility.

Referring to FIG. 5, in order for the mobility to quickly reach a target speed v1 from an initial speed v0, the controller 220 may generate a control signal for controlling the instantaneous speed to be increased by additionally supplying (discharging the second battery) the output of the second battery to the module to assist the output of the first battery. The controller 220 may generate a control signal for controlling the outputs of the first battery and the second battery to gradually reduce the use of the second battery by increasing the output of the first battery while causing the mobility to reach the target speed v1 by increasing the output of the second battery. That is, the controller 220 may discharge the second battery to quickly reach the target speed v1 of the mobility, and may generate a control signal for controlling a discharging operation of the second battery to be stopped when the target speed v1 of the mobility is maintained merely with the output of the first battery.

Referring to FIG. 6, in order for the mobility to quickly reach the target speed v1 from the initial speed v0, the controller 220 may generate a control signal for controlling the instantaneous speed to be reduced by charging the second battery based on a voltage supplied to the module to assist the power supply (output) of the first battery. The controller 220 may generate a control signal for controlling the operations of the first battery and the second battery to gradually reduce the charging of the second battery by reducing the output of the first battery while causing the mobility to reach the target speed v1 by charging the second battery. That is, the controller 220 may charge the second battery to quickly reach the target speed v1 of the mobility, and may generate a control signal for controlling a power recovery operation of the second battery to be stopped when the target speed v1 of the mobility is maintained merely with the output of the first battery.

Referring back to FIG. 3, the controller 220 may generate a control signal for controlling to perform balancing between the second batteries, when an SOC or SOH deviation between the second batteries is greater than or equal to the reference value. For example, the controller 220 may determine whether a deviation in SOC or SOH of each second battery, obtained in the information obtaining unit 210, is greater than or equal to the reference value, and determine a second battery having a deviation greater than or equal to the reference value. By controlling a control signal for increasing the outputs of the other second batteries than the second battery having the deviation greater than or equal to the reference value, the controller 220 may control the mobility to be driven normally by additionally using a module including the other second batteries, and perform balancing between the second batteries.

When abnormality occurs in at least one of the second batteries, the control apparatus 220 may generate a control signal for controlling the operations of the first battery and the second battery to perform the emergency driving mode of the mobility based on the operation of the first battery and the operations of the other second batteries than the second battery having abnormality. For example, the controller 220 may determine whether abnormality occurs in at least one of the second batteries and identify the second battery having abnormality. When it is possible to drive the mobility at an existing target speed based on the outputs of the first battery and the other second batteries than the second battery having abnormality, the controller 220 may generate a control signal for controlling the operations of the first battery and the second batteries to stop using the second battery having abnormality and to allow the mobility to perform emergency driving based on the outputs of the first battery and the other second batteries than the second battery having abnormality.

When the number of second batteries having abnormality among the second batteries is greater than or equal to a preset value, the controller 220 may generate a control signal for controlling the operation of the first battery to perform the emergency driving mode of the mobility based on the output of the first battery. For example, when the number of second batteries having abnormality is greater than or equal to the preset value and thus it is difficult to drive the mobility at an existing driving speed with the outputs of the first battery and the second batteries having no abnormality, then the controller 220 may generate a control signal for controlling the operations of the first battery and the second battery to stop using the second battery and to perform emergency driving on the mobility merely with the output of the first battery.

When abnormality occurs in the first battery, the controller 220 may generate a control signal for controlling the operations of the first battery and the second battery to perform the emergency driving mode of the mobility based on the operation of the second battery. For example, when abnormality occurs in the first battery, the controller 220 may operate by being supplied with power of any one of the second batteries, and generate a control signal for controlling the operations of the first battery and the second battery to stop using the first battery and to perform emergency driving on the mobility merely with the output of the second battery.

In the battery control apparatus 200 according to an embodiment disclosed herein, the controller 220 may generate a control signal for controlling the operations of the first battery and the second battery based on the information obtained in the information obtaining unit 210, thus allowing the mobility to reach the target speed and the target instantaneous speed, matching the degree of degradation between the second batteries, and performing the emergency driving mode on the mobility. That is, the battery control apparatus 200 may efficiently perform the driving of the mobility and the use of the battery by controlling the operations of the first battery and the second battery.

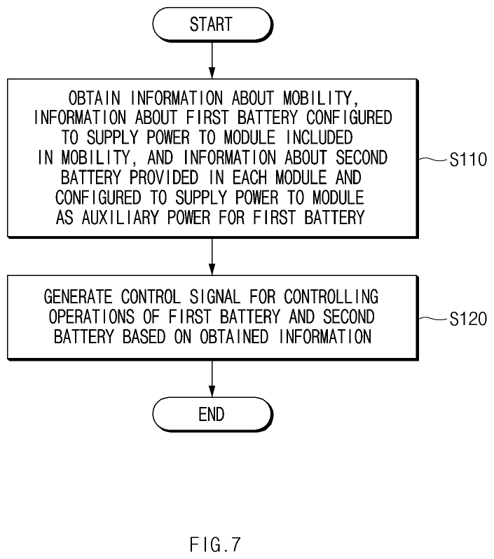

FIG. 7 is a flowchart of an operating method of a battery control apparatus according to an embodiment disclosed herein.

Referring to FIG. 7, an operating method of the battery control apparatus 200 according to an embodiment disclosed herein may include operation S110 of obtaining information about mobility, information about a first battery configured to supply power to each module included in the mobility, and information about a second battery provided in each module and configured to supply power to the module as an auxiliary power source for the second battery based on an operation of the mobility, and operation S120 of generating a control signal for controlling operations of the first battery and the second battery based on the obtained information.

In operation S110 of obtaining the information about the mobility, the information about the first battery configured to supply power to each module included in the mobility, and the information about the second battery provided in each module and configured to supply power to the module as the auxiliary power source for the second battery based on the operation of the mobility, the information obtaining unit 210 may obtain the information about the mobility, the information about the first battery, and the information about the second battery. For example, the information about the mobility may include at least any one of a target speed, a target instantaneous speed, a current speed, a maximum speed, or a minimum speed of the mobility. In another example, each of the information about the first battery and the information about the second battery may include at least any one of a voltage, a current, a temperature, an insulating resistance, an SOC, an SOH, or a failure of the first battery and the second battery.

In operation S120 of generating the control signal for controlling the operations of the first battery and the second battery based on the obtained information, the controller 220 may control the operations of the first battery and the second battery based on the information about the mobility, the information about the first battery, and the information about the second battery, obtained from the information obtaining unit 210. For example, in operation S120, the controller 220 may generate a control signal for controlling the second battery to assist the power supply (output) of the first battery by charging or discharging the second battery based on the speed or instantaneous speed of the mobility.

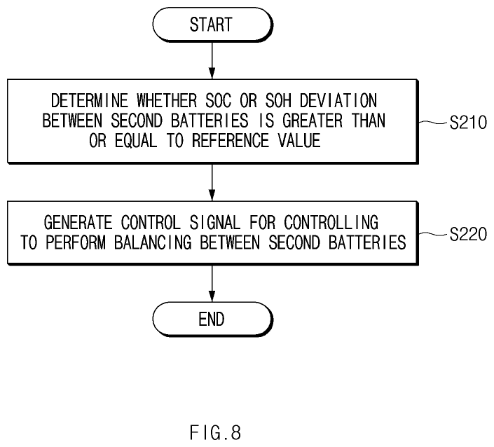

FIGS. 8 to 10 further illustrate an operating method of a battery control apparatus according to an embodiment disclosed herein.

Referring to FIG. 8, an operating method of the battery control apparatus 200 according to an embodiment disclosed herein may include operation S210 of determining whether an SOC or SOH deviation between second batteries is greater than or equal to a reference value and operation S220 of generating a control signal for controlling to perform balancing between the second batteries. In an embodiment, operations S210 and S220 may be included in operation S120 of FIG. 7.

In operation S210 of determining whether the SOC or SOH deviation between the second batteries is greater than or equal to the reference value, the controller 220 may determine whether the SOC or SOH deviation between the second batteries is greater than or equal to the reference value. For example, the controller 220 may identify a second battery having an SOC or SOH deviation being greater than or equal to the reference value.

In operation S220 of generating the control signal for controlling to perform balancing between the second batteries, the controller 220 may generate the control signal for controlling to perform balancing between the second batteries. For example, the controller 220 may match the degrees of degradation between the second batteries by increasing the outputs of the other second batteries than the second battery having the SOC or SOH deviation being greater than or equal to the reference value.

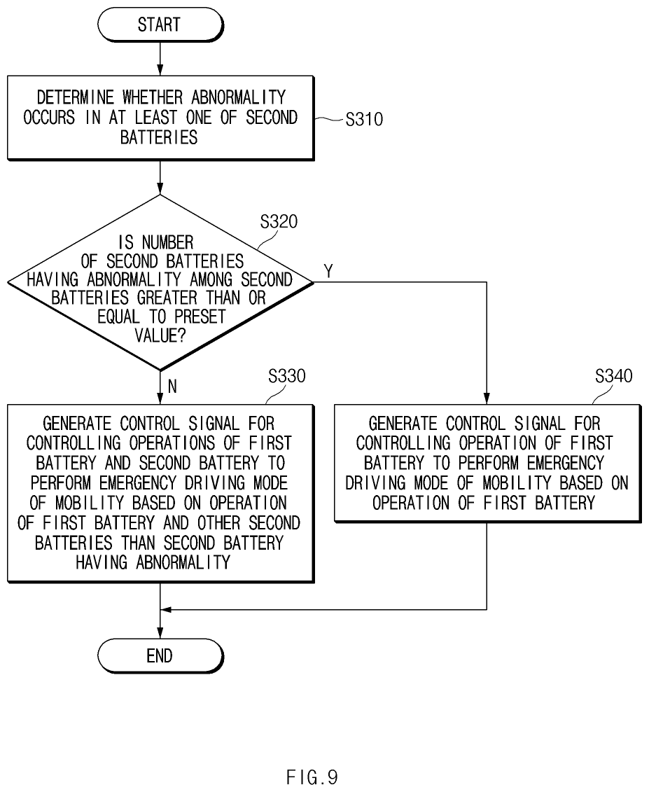

Referring to FIG. 9, an operating method of the battery control apparatus 200 according to an embodiment disclosed herein may include operation S310 of determining whether abnormality occurs in at least one of second batteries, operation S320 of determining whether the number of second batteries having abnormality among the second batteries is greater than or equal to a preset value, operation S330 of generating a control signal for controlling operations of the first battery and the second battery to perform an emergency driving mode of mobility based on the operation of the first battery and the operations of the other second batteries than the second battery, and operation S340 of generating a control signal for controlling the operation of the first battery to perform the emergency driving mode of the mobility based on the operation of the first battery. In an embodiment, operations S310 and S330 may be included in operation S120 of FIG. 7. In another embodiment, operation S120 of FIG. 7 may further include operations S320 and S340.

In operation S310 of determining whether abnormality occurs in at least one of the second batteries, the controller 220 may determine whether abnormality occurs in at least one of the second batteries. For example, the controller 220 may determine whether abnormality occurs in at least one of the second batteries based on failure information or a specific physical quantity obtained in the information obtaining unit 210.

In operation S320 of determining whether the number of second batteries having abnormality is greater than or equal to the preset value, the controller 220 may set the preset value based on a target speed of the mobility and determine whether the number of second batteries having abnormality among the second batteries is greater than or equal to the preset value. The controller 220 may perform operation S340 when the number of second batteries having abnormality is greater than or equal to the preset value, and perform operation S330 when the number of second batteries having abnormality is less than the preset value.

In operation S330 of generating the control signal for controlling the operations of the first battery and the second battery to perform the emergency driving mode of the mobility based on the operation of the first battery and the operations of the other second batteries than the second battery having abnormality, the controller 220 may generate the control signal for controlling the operations of the first battery and the second battery to perform the emergency driving mode of the mobility based on the operations of the other second batteries than the second battery having abnormality and the operation of the first battery. For example, the target speed of the mobility may be reached based on the output of the first battery and the outputs of the other second batteries than the second battery having abnormality, and thus the controller 220 may perform emergency driving on the mobility by generating the control signal for stopping using the second battery having abnormality and controlling the operation of the first battery and the operations of the other second batteries.

In operation S340 of generating the control signal for controlling the operations of the first battery and the second battery to perform the emergency driving mode of the mobility based on the operation of the first battery, the controller 220 may generate the control signal for controlling the operations of the first battery and the second battery to perform the emergency driving mode of the mobility based on the output of the first battery. For example, the target speed of the mobility may not be reached based on the output of the first battery and the outputs of the other second batteries than the second battery having abnormality, and thus the controller 220 may generate the control signal for stopping using all of the second batteries and controlling the mobility to be driven merely with the output of the first battery.

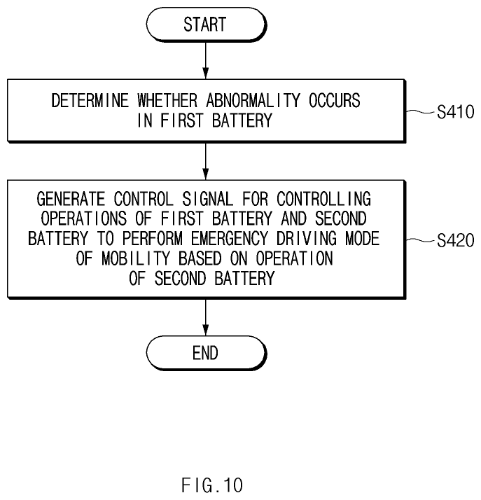

Referring to FIG. 10, the operating method of the battery control apparatus 200 according to an embodiment disclosed herein may include operation S410 of determining whether abnormality occurs in the first battery and operation S420 of generating a control signal for controlling the operations of the first battery and the second battery to perform the emergency driving mode of the mobility based on the operation of the second battery. In an embodiment, operations S410 and S420 may be included in operation S120 of FIG. 7.

In operation S410 of determining whether abnormality occurs in the first battery, the controller 220 may determine whether abnormality occurs in the first battery based on information obtained in the information obtaining unit 210. For example, when abnormality occurs in the first battery, the controller 220 may generate the control signal for controlling the operations of the first battery and the second battery to allow the mobility to be driven normally.

In operation S420 of generating the control signal for controlling the operations of the first battery and the second battery to perform the emergency driving mode of the mobility based on the operation of the first battery, due to a situation where the controller 220 is not able to use the output of the first battery, the controller 220 may generate the control signal for being supplied with power from any one of the second batteries, stopping using the first battery, and controlling the operations of the first battery and the second battery to perform the driving of the mobility based on the output of the second battery.

The above description is merely illustrative of the technical idea of the present disclosure, and various modifications and variations will be possible without departing from the essential characteristics of embodiments of the present disclosure by those of ordinary skill in the art to which the embodiments disclosed herein pertains.

Therefore, the embodiments disclosed herein are intended for description rather than limitation of the technical spirit of the embodiments disclosed herein and the scope of the technical spirit of the present disclosure is not limited by these embodiments disclosed herein. The protection scope of the technical spirit disclosed herein should be interpreted by the following claims, and all technical spirits within the same range should be understood to be included in the range of the present disclosure.

1. A battery control apparatus comprising:
an information obtaining unit configured to obtain information about a mobility, information about a first battery configured to supply power to a module included in the mobility, and information about a second battery provided in the module and configured to supply power to the module as an auxiliary power source for the first battery based on an operation of the mobility; and
a controller configured to generate a control signal for controlling an operation of the first battery and an operation of the second battery based on the information about the mobility, the information about the first battery, and the information about the second battery.

2. The battery control apparatus of claim 1, wherein the controller is further configured to generate a control signal for controlling the second battery to assist power supply of the first battery by charging or discharging the second battery based on a speed or an instantaneous speed of the mobility.

3. The battery control apparatus of claim 1, wherein the second battery is provided in plural, and
wherein the controller is further configured to generate a control signal for controlling to perform balancing between the plurality of second batteries when a deviation in state of charge (SOC) or state of health (SOH) between the plurality of second batteries is greater than or equal to a reference value.

4. The battery control apparatus of claim 1, wherein the second battery is provided in plural, and
wherein the controller is further configured to, when an abnormality occurs in at least one second battery, generate a control signal for controlling the operations of the first battery and the second battery to perform an emergency driving mode of the mobility based on the operation of the first battery and operations of the plurality of second batteries other than the at least one second battery having the abnormality.

5. The battery control apparatus of claim 4, wherein the controller is further configured to, when a number of the plurality of second batteries having the abnormality among the plurality of second batteries is greater than or equal to a preset value, generate a control signal for controlling the operations of the first battery and the second battery to perform the emergency driving mode of the mobility based on the operation of the first battery.

6. The battery control apparatus of claim 1, wherein the controller is further configured to, when an abnormality occurs in the first battery, generate a control signal for controlling the operations of the first battery and the second battery to perform the emergency driving mode of the mobility based on the operation of the second battery.

7. An operating method of a battery control apparatus, the operating method comprising:
obtaining information about a mobility, information about a first battery configured to supply power to a module included in the mobility, and information about a second battery provided in the module and configured to supply power to the module as an auxiliary power source for the first battery based on an operation of the mobility; and
generating a control signal for controlling an operation of the first battery and an operation of the second battery based on the information about the mobility, the information about the first battery, and the information about the second battery.

8. The operating method of claim 7, wherein the generating of the control signal for controlling the operations of the first battery and the second battery, based on the obtained information comprises generating a control signal for controlling the second battery to assist power supply of the first battery by charging or discharging the second battery based on a speed or an instantaneous speed of the mobility.

9. The operating method of claim 7, wherein the second battery is provided in plural, and
wherein the generating of the control signal for controlling the operations of the first battery and the second battery, based on the obtained information comprises:
determining whether a deviation in a state of charge (SOC) or a state of health (SOH) between the plurality of second batteries is greater than or equal to a reference value; and
generating a control signal for controlling to perform balancing between the plurality of second batteries.

10. The operating method of claim 7, wherein the second battery is provided in plural, and
wherein the generating of the control signal for controlling the operations of the first battery and the second battery, based on the obtained information comprises:
determining whether an abnormality occurs in at least one second battery; and
generating a control signal for controlling the operations of the first battery and the second battery to perform an emergency driving mode of the mobility based on the operation of the first battery and operations of the plurality of second batteries other than the at least one second battery having the abnormality.

11. The operating method of claim 10, wherein the generating of the control signal for controlling the operations of the first battery and the second battery, based on the obtained information further comprises:
determining whether a number of the plurality of second batteries having the abnormality among the plurality of second batteries is greater than or equal to a preset value; and
generating a control signal for controlling the operations of the first battery and the second battery to perform the emergency driving mode of the mobility based on the operation of the first battery.

12. The operating method of claim 7, wherein the generating of the control signal for controlling the operations of the first battery and the second battery, based on the obtained information comprises:
determining whether an abnormality occurs in the first battery; and
generating a control signal for controlling the operations of the first battery and the second battery to perform the emergency driving mode of the mobility based on the operation of the second battery.

13. A battery control system comprising:
a first battery configured to supply power to a module included in a mobility;
a second battery provided in the module and configured to supply power to the module as an auxiliary power source for the first battery based on an operation of the mobility; and
a control apparatus configured to obtain information about the mobility, information about the first battery, and information about the second battery and control operations of the first battery and the second battery based on the obtained information.

14. The battery control system of claim 13, wherein the control apparatus is further configured to control to assist power supply of the first battery by charging or discharging the second battery based on a speed or an instantaneous speed of the mobility.

15. The battery control system of claim 13, wherein the second battery is provided in plural, and
wherein the control apparatus is further configured to control to perform balancing between the plurality of second batteries when a deviation in a state of charge (SOC) or a state of health (SOH) between the plurality of second batteries is greater than or equal to a reference value.

16. The battery control system of claim 13, wherein the second battery is provided in plural, and
wherein the control apparatus is further configured to, when an abnormality occurs in at least one second battery, perform an emergency driving mode of the mobility based on the operation of the first battery and operations of the plurality of second batteries other than the at least one second battery having the abnormality.

17. The battery control system of claim 16, wherein the control apparatus is further configured to, when a number of the plurality of second batteries having the abnormality among the plurality of second batteries is greater than or equal to a preset value, perform the emergency driving mode of the mobility based on the operation of the first battery.

18. The battery control system of claim 13,
wherein the control apparatus is further configured to, when an abnormality occurs in the first battery, perform the emergency driving mode of the mobility based on the operation of the second battery.
